(19) United States
(12) Patent Application Publication
(10) Pub. No.: US 2009/0286558 A1
(43) Pub. Date: Nov. 19, 2009

(54) COMMUNICATION METHOD, APPARATUS AND SYSTEM

(76) Inventors: Carl Zufi, Victoria (AU); Jonathan Zufi, Victoria (AU)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/721,994

(22) PCT Filed: Dec. 14, 2005
(86) PCT No.: PCT/AU2005/001883

§ 371 Date: Jun. 18, 2007

(30) Foreign Application Priority Data
Dec. 21, 2004 (AU) 2004907209

(51) Int. Cl. H04W 4/14

(52) U.S. Cl. 455/466

(57) ABSTRACT

The present invention relates to a method of enabling content for transmission in a mobile communication network, including the step of transferring at least one element of a content resource to a mobile message editor. The content resource is adapted for selecting and transferring elements. A mobile message is composed in the mobile message editor, the mobile message comprising the at least one transferred element.

### FIELD OF THE INVENTION

The present invention relates to the field of telecommunications. In particular, the present invention relates to a method and system of enabling content for transmission in a mobile communications network.

### BACKGROUND OF THE INVENTION

Attempts have been made to provide interaction between mobile devices and networks, which networks are capable of providing data and information for user viewing or interaction. Conventional systems enabling network interaction for enhanced mobile devices are typically limited to communications between a network and a particular mobile device that requests the delivery of specific content. Typical systems fail to provide a system in which content residing on a network or computer system may be readily enabled for delivery to any number of mobile devices operating in accordance with conventional mobile access network procedures.

Processes provided by conventional systems may be unacceptably complex and time consuming for a variety of reasons, including convoluted mechanisms for transferring content from the web page to a composer, complicated media formatting requirements, or multiple components with which a user must interact. For example, transferring text may involve selecting the relevant text in the browser, copying it to the clipboard, then switching to the composer application, and then pasting and formatting the text. In some alternate systems, which attempt to provide automated processes for transferring content, typical systems may fail to provide users with the ability to customize transfers, may provide only limited options for transfers, or may increase the complexity and level of effort required by the operator of a web page. One of the most significant problems in conventional systems is the burden on the user to be concerned about media formats, e.g. typical MMS composers rely on the user to supply media that has (a) an acceptable image format, (b) acceptable image dimensions, and (c) a manageable file size.

### SUMMARY OF THE INVENTION

The present invention relates to a method and system of enabling content for transmission in a mobile communications network. In one aspect, the present invention relates to the delivery of content of various media to mobile or wireless devices. In another aspect, the present invention relates to a platform for the delivery of content to various devices. In one embodiment, the invention relates to the delivery of information to mobile phones.

In one aspect, the present invention provides a method of enabling content for transmission in a mobile communication network including the step of adapting a content resource for selection and transfer of an element in the content resource. The element in the content resource is transferred to a mobile message editor. A mobile message comprising the at least one transferred element is composed in the mobile message editor.

In one embodiment, the element in the content resource is selected by a user of the content resource. In another embodiment, the user selects the element, drags the element to the mobile message editor, and places the element in the mobile message editor. In still another embodiment, transferred elements may be converted into a form suitable for transmitting to a separate component distinct from the mobile message editor.

In another aspect, the present invention relates to a system for enabling transmission of content in a mobile communication network including a content resource, an automated structure and a mobile message editor. The content resource comprises at least one element. The automated structure transmits the at least one element. The mobile message editor receives the at least one element and generates a mobile message for transmitting the at least one element.

In one embodiment, the content resource includes the automated structure. In another embodiment, the content resource is a web page. In another embodiment, the content resource is a file system. In some embodiments, the at least one element is a media type. In one of these embodiments, the at least one element is an image. In another of these embodiments, the at least one element is text. In still another of these embodiments, the at least one element is audio. In yet another of these embodiments, the at least one element is video.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A and FIG. 1B are block diagrams depicting embodiments of a computer useful in connection with the present invention;

FIG. 2 is a flow diagram depicting one embodiment of the steps taken to transmit an element from a content resource to a mobile device;

FIG. 3 is a flow diagram depicting one embodiment of the steps taken by a mobile message editor to store copies of elements of a content resource;

FIG. 4 is a flow diagram depicting one embodiment of the steps taken in a method for creation and transmission of messages;

FIG. 5 is a screen shot of one embodiment of a browser integrated with the mobile message editor;

FIG. 6 is a screen shot of one embodiment of a local file system integrated with the mobile message editor;

FIG. 7 is a screen shot of one embodiment in which a transferred element may be dragged from an enumerated list in a content resource and dropped into a mobile message editor; and

FIG. 8 is a screen shot of one embodiment in which an image of a content resource may be added to a mobile message editor.

### DETAILED DESCRIPTION OF THE INVENTION

The present invention provides a method enabling integration of online message composition with web content without requiring a switch to another application. Additionally, the present invention provides seamless message composition supporting varied media types, including video and audio, with seamless delivery experience through techniques including, but not limited to drag and drop, optional web scripting, online address book, online message transaction history and the ability to send to more than one recipient. Furthermore, the present invention allows users to effectively send varying media types while automatically transcoding the media to ensure that each recipient receives a message formatted for their own device.

One embodiment of the present invention allows the user to send any element, for example an image from a web page, they view in a content resource, for example, a website visited by their web browser to a phone. Another embodiment of the present invention allows the user to send any content on their own computer to a phone. Still another embodiment of the present invention enables combinations of the above embodiments. An element of a content resource may include, without limitation, content in the form of image, text, audio, video, a document, a URL (Uniform Resource Locator) or URI (Universal Resource Identifier), and HTML. A content resource may, without limitation, be a source of an element as defined above such as a web page, a local file system or an application program. In some embodiments, message composition is merged with a computer at the point where the content resource resides. In one of these embodiments, the present invention allows but does not require the saving of content on a local computer, nor is context switching between multiple applications required.

In one embodiment, a seamless ‘snap-in’ in a web browser enables a user to easily drag content to the software mechanism of the invention for delivery to a mobile device. The present invention enables adaptation of website content while minimizing time and effort requirements.

In some embodiments, users may select content and compose a message with the selected content. In one of these embodiments, the message may be edited or have content inserted by a user and may be transmitted to multiple destinations, including mobile devices. The user may also specify a text message to accompany their media and a message subject. Multiple images may be compiled into a slideshow or animated GIF to enhance the experience of a recipient user receiving the message.

Some embodiments of the present invention provide techniques useful to web site operators. In one of these embodiments, web site content can be mobile-enabled without being formatted for a single target device through client-side scripting without backend processing, and additionally provides a method for static content to be mobile enabled. In another of these embodiments, the present invention enables web site operators to enhance user experience of the web site while generating additional revenue opportunities by sharing in the fees involved in delivering the message without the need to setup and maintain billing systems.

Other embodiments of the present invention provide techniques useful to users of content resources. In one of these embodiments, complexity involved in composing and delivering content from a web browser to a mobile device is reduced while choice of delivery technologies are increased and a wide variety of devices and configurations is supported. In another of these embodiments, customization abilities are provided enabling users to quickly send a message without having to manually compose it, specify multiple recipients, customize a message as defined by the web site, avoid the need for specific formatting of media content for particular mobile devices. In still another of these embodiments, flexible payment methods may be provided. In yet another of these embodiments, tools such as online address books may be provided.

In some embodiments of the present invention, multiple methods of message composition may be provided. In one of these embodiments, a web site operator may add scripting to a web page to specify content to add to the message. In another of these embodiments, a user may select content and drag and drop the selected content for delivery to a mobile phone, or manually add content (for example, type in the message text), or a combination of all of these forms (i.e. drag and drop, manually adding content or use the web page script supplied by the web site). In still another of these embodiment, the user is not required to format the media they want to send or identify an ability of a recipient to receive the message. In yet another of these embodiments, the invention provides a method for automatically determining device capability and formatting a message in real time for delivery to a specified recipient device.

In one embodiment, a method of message composition may be integrated with varying integration with different operating systems (such as Microsoft WINDOWS, Apple Macintosh, or UNIX), different devices (such as PDAs). In another embodiment, a system may provide different variations of a ‘snap-in’ element, including without limitation floating windows, framed web page, integration with other applications (Instant messaging, media players, etc).

In one embodiment of the present invention, a process and system whereby users can send website content viewed in a browser (or other application capable of rendering HTML) to a mobile device. The content may be sent via mobile messaging technologies, and the content may include text and/or media (images, audio, or video). Content may include any information which is deliverable to a remote device such as, without limitation, short message service (SMS), Multimedia Message Service (MMS), or other information retrieved from the Internet. In some embodiments, content comprises Premium SMS, a mechanism whereby users may pay an extra cost for products and services associated with sending or receiving a SMS message.

In some embodiments, a content source resides on a computer and displays elements to a user of the computer. In other embodiments, an element on the content resource is displayed to a user of a mobile device. In some embodiments, the mobile device is a personal digital assistant. In other embodiments, the mobile device is a cellular telephone. In other embodiments, the mobile device is a laptop computer. In other embodiments, the mobile device is a desktop computer. In other embodiments, the mobile device is an Internet kiosk.

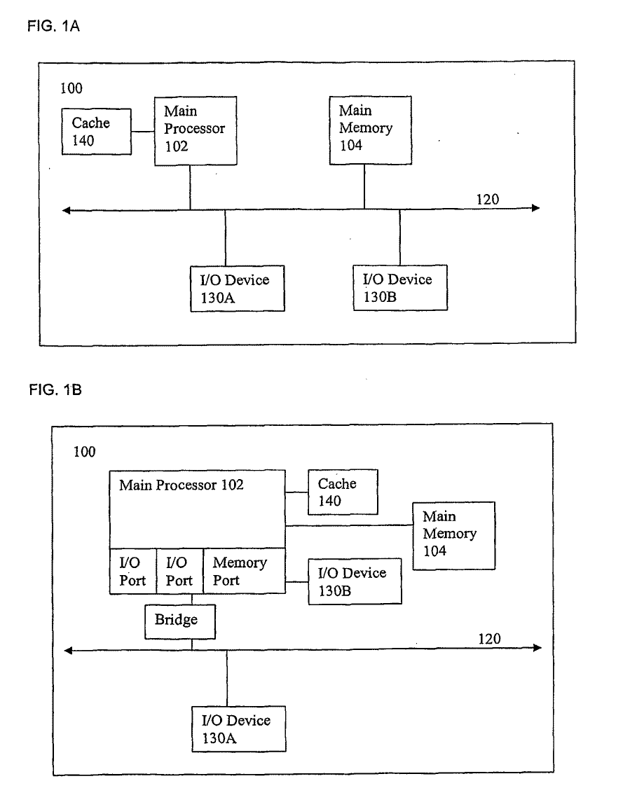

For embodiments including a mobile device, the mobile device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. A typical mobile device may comprise many of the elements described in FIGS. 1A and 1B, below, including the processor 102 and the main memory 104.

In other embodiments including a mobile device, it may be a personal digital assistant (PDA) operating under control of the PalmOS operating system, such as the Tungsten W, the VII, the VIIx, the i705, all of which are manufactured by palmOne, Inc. of Milpitas, Calif. In further embodiments, the mobile device may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, Calif.; or the Toshiba PocketPC e405, manufactured by Toshiba America, Inc. of New York, N.Y. In still other embodiments, the mobile device is a combination PDA/telephone device such as the Treo 180, Treo 270, Treo 600, or the Treo 650, all of which are manufactured by palmOne, Inc. of Milpitas, Calif. In still further embodiments, the mobile device is a cellular telephone that operates under control of the PocketPC operating system, such as the MPx200, manufactured by Motorola Corp. A typical combination PDA/telephone device may comprise many of the elements described below in FIGS. 1A and 1B, including the processor 102 and the main memory 104.

FIGS. 1A and 1B depict block diagrams of embodiments in which the mobile device comprises a typical computer 100 or the content resource resides on a typical computer 100. The computer 100 may be provided as a personal computer or computer server, of the sort manufactured by the Hewlett-Packard Corporation of Palo Alto, Calif., or the Dell Corporation of Round Rock, Tex. As shown in FIGS. 1A and 1B, each computer 100 includes a central processing unit 102, and a main memory unit 104. Each computer 100 may also include other optional elements, such as one or more input/output devices 130a-130n (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 1A, the processor 102 communicates with main memory 104 via a system bus 120 (described in more detail below). FIG. 1B depicts an embodiment of a computer system 100 in which the processor communicates directly with main memory 104 via a memory port. For example, in FIG. 1B, the main memory 104 may be DRDRAM.

FIGS. 1A and 1B depict embodiments in which the main processor 102 communicates directly with cache memory 140 via a secondary bus, sometimes referred to as a “backside” bus. In other embodiments, the main processor 102 communicates with cache memory 140 using the system bus 120. Cache memory 140 typically has a faster response time than main memory 104 and is typically provided by SRAM, BSRAM, or EDRAM.

In the embodiment shown in FIG. 1A, the processor 102 communicates with various I/O devices 130 via a local system bus 120. Various buses may be used to connect the central processing unit 102 to the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 102 may use an Advanced Graphics Port (AGP) to communicate with the display. FIG. 1B depicts an embodiment of a computer 100 in which the main processor 102 communicates directly with I/O device 130b via HyperTransport, Rapid I/O, or InfiniBand. FIG. 1B also depicts an embodiment in which local busses and direct communication are mixed: the processor 102 communicates with I/O device 130a using a local interconnect bus while communicating with I/O device 130b directly.

A wide variety of I/O devices 130 may be present in the computer system 100. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 100 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif., and the iPod Shuffle line of devices manufactured by Apple Computer, Inc., of Cupertino, Calif.

In further embodiments, an I/O device 130 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIG. 1A and FIG. 1B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

A computer 100 may also be any personal computer (e.g., 286-based, 386-based, 486-based, Pentium-based, Pentium II-based, Pentium III-based, Pentium 4-based, Pentium M-based, or Macintosh computer), Windows-based terminal, Network Computer, wireless device, information appliance, RISC Power PC, X-device, workstation, mini computer, main frame computer, personal digital assistant, or other computing device. Windows-oriented platforms supported by the computer 200 can include, without limitation, WINDOWS 3.x, WINDOWS 95, WINDOWS 98, WINDOWS NT 3.51, WINDOWS NT 4.0, WINDOWS 2000, WINDOWS CE, WINDOWS ME, WINDOWS XP, WINDOWS Longhorn, MAC/OS, Java, and UNIX. The computer 100 can include a visual display device (e.g., a computer monitor), a data entry device (e.g., a keyboard), persistent or volatile storage (e.g., computer memory) for storing downloaded application programs, a processor, and a mouse. Execution of a communication program allows the system 100 to participate in a distributed computer system model.

In some embodiments, a mobile device and a computer 100 on which the content resource resides communicate over a network connection. The network can be a local area network (LAN), a metropolitan area network (MAN), or a wide area network (WAN) such as the Internet. The mobile device and the computer 100 may connect to a network through a variety of connections including standard telephone lines, LAN or WAN links (e.g., T1, T3, 56 kb, X.25), broadband connections (ISDN, Frame Relay, ATM), and wireless connections. Connections between the mobile device and the computer 100 may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections).

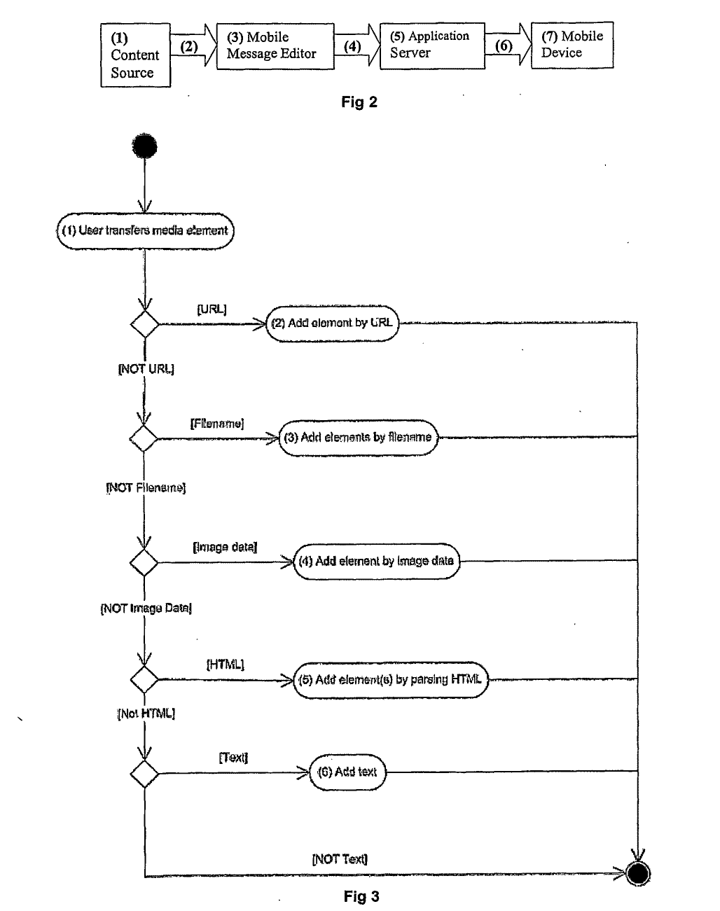

Referring now to FIG. 2, a flow diagram depicting one embodiment of the steps taken by a system for transmitting an element from a content resource to a mobile device, including a content source 1, a mobile message editor 3 (MME 3), an application server 5, and a mobile device 7. In brief overview, the content source 1 may include, without limitation, HTML, images, audio, video, text, local filenames, and URL's. Elements from the content resource 1 are transferred 2 to the mobile message editor 3. The mobile message editor 3 allows mobile messages to be composed. The message contents are sent (4) to an application server. The application server 5 receives a request from the mobile message editor 3 to send a mobile message and then sends the message to the mobile device 6. The mobile device 7 receives the message sent by the application server 5.

The content source 1 may reside in an application running on a computer 100, or as a file on a local file system, in which case, the content resource may be located in a file browser. In one embodiment, an element in the content resource may comprise one of, without limitation, an image, a text, an audio, and a video. A content resource in the form of HTML may be loaded in an application that can render HTML. In one embodiment, the HTML page is loaded and rendered in a web browser.

In one embodiment, the mobile message editor 3 generates an MMS message that may contain a combination of text and/or media elements. Examples of media elements include images, audio and video etc. The HTML page may be constructed by the website operator in such a way that allows text and/or media elements to be added to the mobile message that is being composed in the mobile message editor 3 in an automated way by or responsive to the HTML.

In one embodiment, the present invention provides a method of enabling content for transmission in a mobile communication network including the step of adapting a content resource for selection and transfer of an element in the content resource. The element in the content resource is transferred to a mobile message editor. A mobile message comprising the transferred element is composed in the mobile message editor.

In one embodiment, the content resource is adapted when an image, such as a screen shot, is generated of a display of the content resource. The screen shot may be accessed for enabling a transfer of an element to the mobile message editor 3. In another embodiment, the mobile message editor presents to a user of the content resource an enumeration of a plurality of elements in the content resource and the user selects one or more elements from the enumeration for transfer to the mobile message editor.

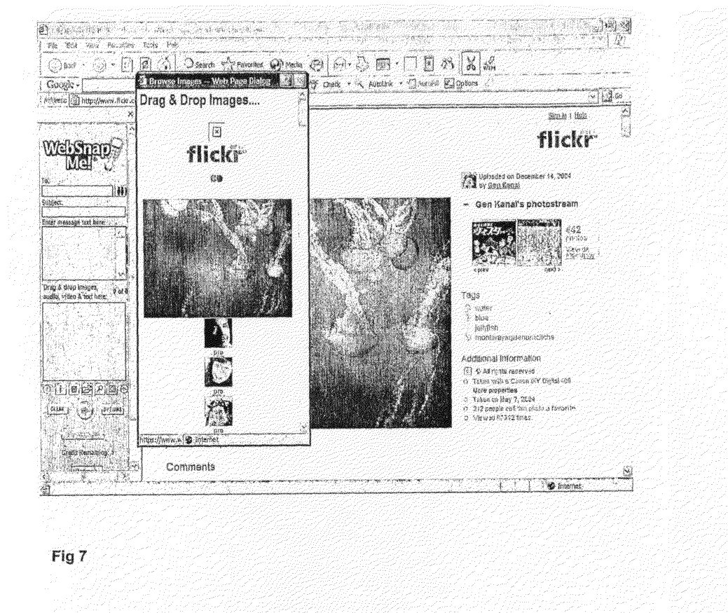

In some embodiments, an element in the content resource is selected for transfer to the mobile message editor 3 by a user of the content resource. Referring ahead to FIG. 7, a screen shot depicts one embodiment in which a transferred element may be dragged from an enumerated list in a content resource and dropped into a mobile message editor. In one of the embodiments depicted by FIG. 7, the user transfers the element to the mobile message editor 3 by selecting the element, dragging the element to the mobile message editor, and placing the element in the mobile message editor.

In another of these embodiments, the user transfers the element to the mobile message editor 3 by copying the element from the content resource and pasting the copy of the element into the mobile message editor 3. In one embodiment, the element selected is a file from a file browser. In another embodiment, the element selected is an element in an HTML web page.

In one embodiment, an HTML page contains a script that programmatically adds elements to the mobile message editor 3. The term programmatically may be understood to mean automatically, because the script may be in the form of software code, and this code may add element(s) to the mobile message editor 3. The term programmatically is used because, in this aspect, the mobile message editor 3 is being controlled by another program. In some embodiments an automated structure of the content resource transfers the element of the content resource to the mobile message editor. In other embodiments, the program is an executable script contained in the HTML page. As an example, an object model may be exposed by mobile message editor 3 to allow a message to be composed programmatically from script contained within a HTML page. The mobile message editor 3 exposes an object model, which means that it provides a mechanism for external programs to control it. This underlies the functionality of the script contained within the web page being able to add elements to the mobile message editor 3 (e.g. programmatically add elements), through this “exposed” object model. The term object model is used herein as a term to describe the interface (set of operations) or way in which an external program may control the mobile message editor 3.

In one embodiment, the mobile message editor 3 may comprise an object called WSMEBLink, which has the following properties and methods:
[method] DoReset( )—clears and resets the message contents
[property] Subject—gets/sets the subject for the message
[property] MessageText—gets/sets the message text
[method] AddImage(url)—add an image attachment to the message
[method] AddMediaElementUrl(url)—add a URL to the message (the URL points to media content that will be downloaded and added to the message.
[method] AddImageSlide(url, duration, forward_lock)—add an image to the message (url is the URL of the image, duration determines how long the image is shown in a SMIL presentation, and if set to TRUE, forward_lock will restrict the message recipient from forwarding the image to others).
[method] AddVideoSlide(url, start_time, duration, forward_lock)—add a video to the message (url is the URL of the video, start_time is the position in the video to start from, duration is the length of video to include, and if set to TRUE, forward_lock will restrict the message recipient from forwarding the video to others).
[method] AddAudioSlide(url, start_time, duration, forward_lock, play_in_background)—add audio to the message (url is the URL of the audio, start_time is the position to start from, duration is the length of audio to include, and if set to TRUE, forward_lock will restrict the message recipient from forwarding the image to others, and if play_in_background is set to TRUE, the audio will play in the background for a SMIL message).
[method] AddTextSlide(text, duration, text_is_url, forward_lock)—add text to the message (text is the text, duration is the length of time to show the text in SMIL presentation, if set text_is_url is set to TRUE, the first parameter is a URL to some text, and if set to TRUE, forward_lock will restrict the message recipient from forwarding the image to others).
[property] CombineImages( )—when set to TRUE, a SMIL presentation will be created for MMS messages

In one embodiment, when the user “clicks” on an image on a HTML page, a script may execute that adds elements to the mobile message editor 3 using the object model described above.

In another embodiment, the HTML page may contain extra markup so that the mobile message editor 3 may parse the HTML and automatically determine the composition of the message. In this embodiment, a script may be contained in a HTML page that will allow the mobile message editor 3 to automatically determine which HTML elements to include in the mobile message.

Typically applications that render HTML ignore elements for which they do not understand. It is therefore possible to add extra tags to HTML that could describe to mobile message editor 3 what elements should be added to the message. For example, to indicate that an image should be added, a custom tag could surround the HTML <IMG> tag as follows:

<WSMIMG><IMG src=“ . . . ”></IMG><WSMIMG>

The mobile message editor 3 can search for the custom <WSMIMG> tags, and then extract the <IMG> tag and it's attributes to determine which image to add.

In general, this may take the form:

<SUPP_TAG><ELEMENT src=“ . . . ”></ELEMENT></SUPP_TAG>

where

<SUPP_TAG> is a supplemental tag for indicating to the mobile message editor that element “<ELEMENT>” with its given source, src=“ . . . ” is to be added to the composed message.

In another embodiment of the invention, some (or all) of the HTML itself may be passed to the mobile message editor 3, which can determine the contents of the message from the HTML. For example, in an embodiment in which the HTML contains an <IMG> tag, the tag will usually contain a “src” attribute whose value is a URL that points to the location where the image data may be found. The mobile message editor 3 may either add the value of the URL to the message, so that the application server can download the image later on or, add the actual image data itself. In some embodiments may include the step of passing actual HTML (text) to the mobile message editor 3, or passing a rendered or parsed representation of the HTML.

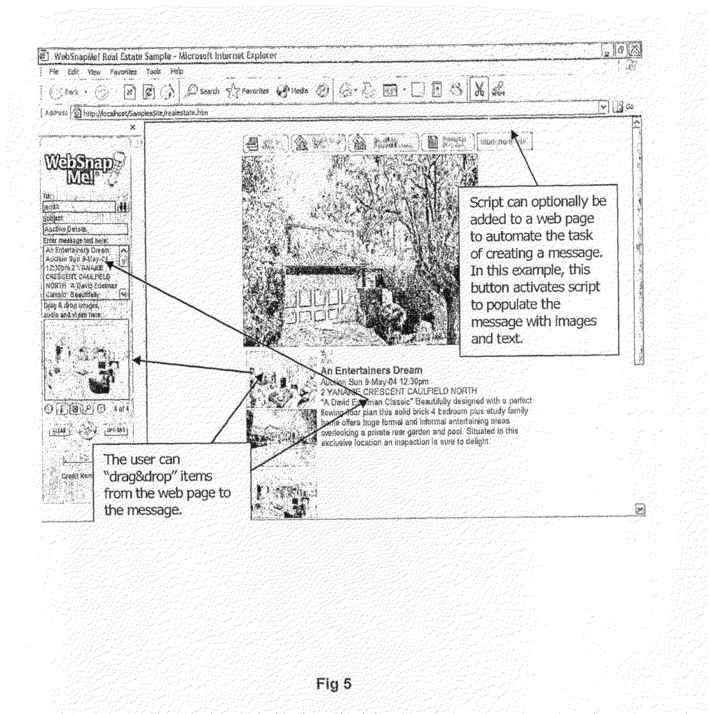

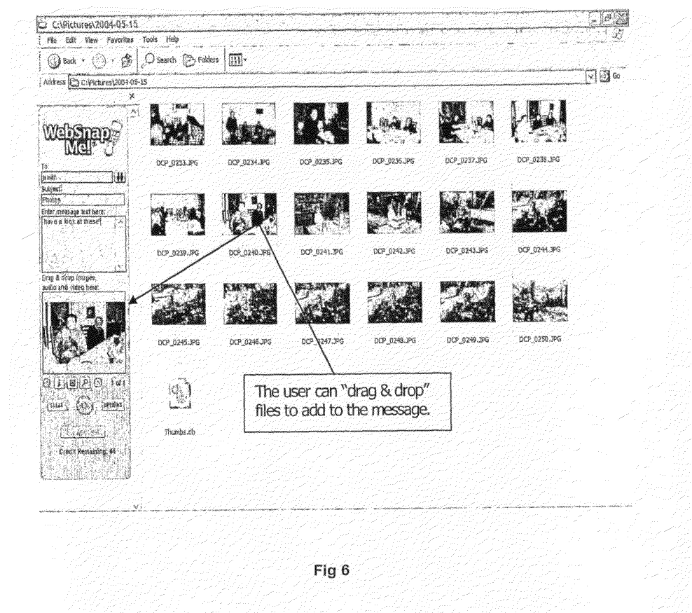

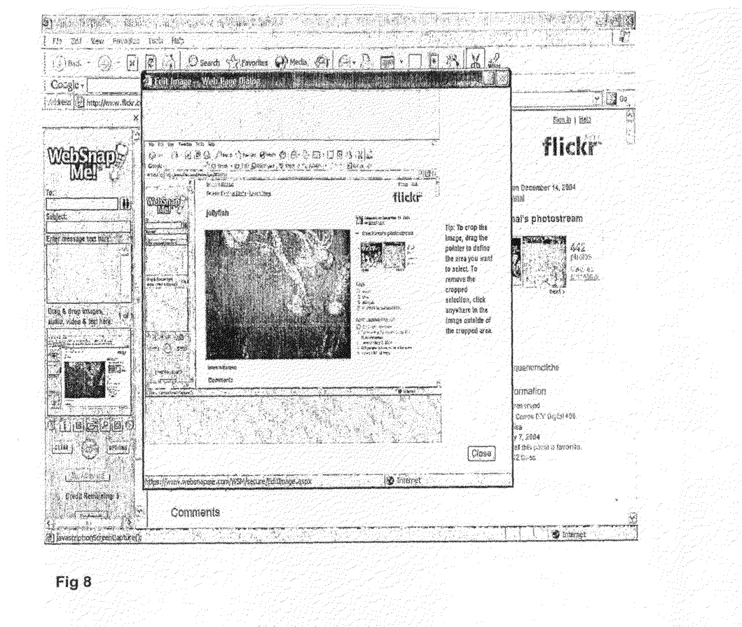

In another embodiment, the mobile message editor 3 is integrated with a web browser as depicted in FIG. 5. In still another embodiment, the mobile message editor 3 may be integrated with a local file browser as depicted in FIG. 6. In some embodiments, the mobile message editor 3 displays a representation of the mobile message being composed. In one embodiment depicted in FIG. 8, a user may edit the message by editing the text and/or altering the media elements (add, delete, etc). The user may select extra elements they wish to transfer from the HTML page to the mobile message editor 3. The exact mechanism for selecting and transferring HTML element(s) will depend on the application that has loaded and rendered the HTML and the capabilities of the mobile message editor 3. The invention may support one or many such mechanisms. In another embodiment, the HTML page is rendered in a browser and the user can “drag & drop” HTML elements from the browser onto the mobile message editor 3. The mobile message editor may store a copy of the transferred HTML elements.

Referring now to FIG. 3, a flow diagram depicts one embodiment of the steps taken to transfer an element. As shown this describes the process of how the mobile message editor 3 (MME) stores a copy of transferred media elements.

(1) The user transfers media element(s) to MME.

(2) If the media element is transferred to MME as a URL, then MME stores a copy of the URL.

(3) If the media element is transferred to MME as the name of a local file, then MME stores a copy of the contents of the local file.

(4) If the element is transferred to MME as media data, then a copy of the media data is stored.

(5) If HTML is transferred to MME, then the HTML is parsed, and elements added to MME. For example:

The “href” attribute of <A> tags are treated as URL's

The “src” attribute of <IMG> tags is treated as a URL.

Text is stored from a number of elements including, <A>, <TD>, <H1>, <P>

(6) If text is transferred to MME, then a copy of the text is stored.

In some embodiments, it is possible to re-arrange this process to achieve the same result. In one of these embodiments, a check may be made of whether the media element was transferred to MME as media data before a check to see if the media element was transferred as a URL and so on. In some embodiments, therefore, a copy of a transferred element is stored in the mobile message editor. In one of these embodiments, the copy of the transferred element is stored in the form of one of:

a) a URL;

b) a local file name and file contents;

c) media data, such as binary, text or Base64 encoded binary;

d) parsed HTML; and

e) text.

In one embodiment, a reference to a transferred element is stored in the mobile message editor.

In one embodiment, the user may use MME to define other attributes of the mobile message including:

A Subject

A recipient list (a list of 1 or more recipients)

In some embodiments, the method further comprises the steps of:
(i) converting message data into a form suitable for transmitting to a separate component distinct from the mobile message editor;
(ii) transmitting the converted message data to the separate component;
(iii) processing by the separate component the message data; and
(iv) sending the processed message data to at least one mobile device, the mobile device able to retrieve the processed message data.

In some embodiments, a user may send the message from the mobile message editor. In one of these embodiments, the mobile message editor converts the message into data in a form that is suitable to be transmitted to a separate component. In another of these embodiments, message data may be altered by the mobile message editor. In still another of these embodiments, the separate component, such as the application server, may alter the message data. In an example of this embodiment, the application server may customize the content for the mobile device. For example, if an image was included in the original message, and the dimensions of the original image differs from the dimensions of the mobile devices screen, the application server may reformat the original image so that it is correctly formatted for the mobile device. In one of these embodiments, data associated with the mobile message is altered. In another of these embodiments, a transferred element is altered. In still another of these embodiment, a scale of an image size is reduced. In yet another of these embodiments, data is converted from one media format to a second media format. In some embodiments, data, including additional content, may be transmitted as an attachment to a message. In other embodiments portions of the data are identified for transmission.

In some embodiments, the data may or may not have a structured form. In other embodiments, the separate component may be an application server. The separate component sends the message to the mobile device. In one embodiment of the invention, the data is in XML format. The XML is sent to the separate component, which loads the XML and processes it.

In some embodiments, when the separate component processes message data, the separate component adds details from Really Simple Syndication (RSS) data to a mobile message. In one of these embodiments, an application server adds information associated with an element tagged as an <item>. In another of these embodiments, an application server adds details associated with each <item> in the RSS data to a mobile message.

In some embodiments, the separate component may be an application server. The application server may store a copy of the transferred element and may retrieve and store, in the form of a URL, a copy of the message data sent for the transferred element. This may be described by an example of how MME converts the transferred HTML elements into XML as follows.

MME stores the transferred HTML elements in memory structures. When the user wants to send the message, MME converts this memory structure to XML text data. The media elements are converted to XML, the following is an example of the schema that is used:

<attachments>

<attachment>

<mediaType></mediaType>
<imgData></imgData>
<srcFilename></srcFilename>
<srcUrl />
<duration />
<forwardLock />
<startTime />
<textIsUrl />
<submitUrlOnly />
<playInBackground />

</attachment>

<attachments>

For each media element, an <attachment> node is added.

The <mediaType> element contains an identifier, which describes the media type; examples include image, video or audio.

When the actual media data is to be sent from MME to the application server, the <imgData> element contains base 64 encoded data.

If a URL was transferred from the content source to MME, then the <srcFilename> element will contain this URL. If the content is sourced from the local file system, then <srcFilename> contains the full path and name of this file. If a URL was transferred from the content source to MME, then the <srcUrl> element will contain this URL.

The <duration> element defines how long the element should be shown in a SMIL presentation.

The <forwardLock> element determines if that element should be sent to the recipient such that the recipient is prevented from sending that element to other users.

The <startTime> element applies to audio and video media elements, and defines the starting position of the media that is sent to the recipient.

The <textlsUrl> element applies to text media elements and defines if the text is a URL to the source text.

The <submitUrlOnly> element indicates that only the URL to the content source is supplied.

The <playInBackground> element only applies to audio media elements, and indicates if the audio should be played in the background for SMIL presentations.

In one embodiment, each message element is separately transmitted and stored on a remote server after it is added to MME 3, rather than as a single transmission of data. In another embodiment of the invention, the component to which the MME 3 sends the data is simply a component within MME 3 itself. In still another embodiment, the data is sent to a separate component available to the MME 3 on the same computer that MME 3 is running on. The application server processes the XML sent from MME 3. The application server may store the element for subsequent transmission to at least one mobile device.

In some embodiments, a user identifies a mobile device type, the application server customizes the content of the message responsive to the identification of the mobile device and sends the customized message to the mobile device, the mobile device receiving a communication having a format selected responsive to a message type.

In one embodiment, the application server performs the following steps:
Save a local copy of each element for which the actual data was sent from MME (this includes text and media content)
For each element transferred as a URL, the data identified by the URL is downloaded and a local copy saved.

After processing the XML data, the application server then sends the message to each recipient—the invention allows the user to determine the mechanism for which the message is sent, on a recipient-by-recipient basis. Example mechanisms include:
MMS Notifications
WAP Push
SMS which contains a URL to the message
MMS sent via MM1 or MM7

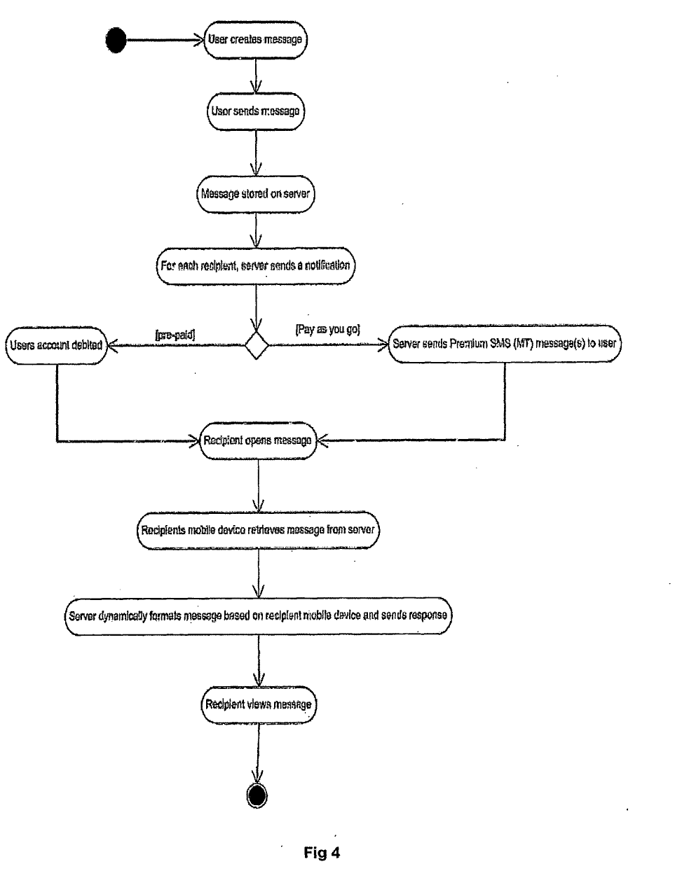

Referring now to FIG. 4, a flow diagram depicts one embodiment of the steps taken in the creation and transmission of messages to a mobile device in accordance with the invention. As illustrated, prior to the user of a mobile device responding to a notification of an incoming message, a payment scheme, which in many forms would be recognized by the person skilled in the art, is enacted before the recipient opens the message. Payment schemes may comprise, for example, such schemes as: per message recipient with Premium SMS (mobile terminated calls); pre-paid with credit card; and pre-paid with Premium SMS (mobile originated calls).

As an alternative to paying for messages, users may elect to send messages for free or at a discounted rate. In some embodiments, the application server may insert additional media content in the message. In one of these embodiments, the additional content that is inserted into the message is an advertisement. In another of these embodiments, the application server may utilize a number of schemes to determine which advertisement is best inserted in which message. The application server may identify information associated with the sender or with the receiver or with a source of the media content being sent and insert additional content responsive to the identification. When identifying information about the user, the application server may access user-provided demographic information, such as age, gender and interests. When identifying information about the recipient, the application server may identify a geographic location to which the message is being sent. When identifying information about the source of the transmitted media content, the application server may identify a source of the content and, based on the identification, determine the demographic best suited for the target advertisement. For example, if the content came from a sports web site, an advertisement relating to sporting goods may be selected. In some embodiments, advertising is selected using a round robin scheme. In other embodiments, advertising is selecting randomly.

In some embodiments, advertisements may also contain a hyperlink. In one of these embodiments, a hyperlink is inserted into the advertisement. In another of these embodiments, a hyperlink enables the message recipient can contact the advertiser. In still another of these embodiments, a hyperlink prompts the advertiser to contact the message recipient. In still another of these embodiments, a hyperlink provides access to additional information associated with the advertisement.

In other embodiments, a communication may be received at a mobile device in accordance with the message type and a second communication may be received by the application server from the mobile device comprising a request to download the message content to the mobile device; and customising the content of the downloaded message in accordance with parameters of the mobile device. In one of these embodiments, the mobile device receives the message or notification, depending on the delivery mechanism used in the steps noted above. When the mobile device contacts a separate component, such as the application server, to download the message, the separate component, such as the application server, is able to customize the content for the mobile device. For example, if an image was included in the original message, and the dimensions of the original image differs from the dimensions of the mobile devices screen, the application server may reformat the original image so that it is correctly formatted for the mobile device. In one of these embodiments, data associated with the mobile message is altered. In another of these embodiments, a transferred element is altered. In still another of these embodiment, a scale of an image size is reduced. In yet another of these embodiments, data is converted from one media format to a second media format. In some embodiments, data, including additional content, may be transmitted as an attachment to a message. In other embodiments portions of the data are identified for transmission.

In still other embodiments, the alterations described above occur prior to the sending of the message to the mobile device. In one of these embodiments, the mobile editor makes the alterations. In another of these embodiments, the application server makes the alterations.

In some embodiments, the mechanism used to deliver the message does not require the mobile device to download the message directly from the application server (examples include messages delivered via MM1 or MM7). In one of these embodiments, the message is customized for the target device prior to being sent by the application server to the mobile device. Examples of how this can be achieved include:
(1) If the user knows the make and model of the target mobile device, they can associate this with each recipient—this information can be saved with other details in the online address book discussed above. When sending a message to the specified recipient, the application server uses this information to customize the message contents prior to sending the message
(2) If the user does not know the make and model of the target mobile device, the application server can help the user detect the device type as follows:
   a. The application server sends a Wireless Access Protocol (WAP) Push message to the recipient's phone on behalf of the user (or an SMS with a WAP URL contained in the text of the message).
   b. The recipient opens the link in the WAP browser on their mobile device
   c. Upon connecting to the Messaging Sever using the link contained in the message, the application server detects the type of device and then associates this information in the users online address book automatically, In future, when the user sends a message to that recipient, the mobile device make and model is now known and messages can be formatted accordingly

Types of MMS messages that may be composed include SMIL and non-SMIL. WSM supports both types and allows the user to select which type to create on a message by message basis. The input to this process is the data submitted to the application server by the MME.

In one embodiment, the process of composing a SMIL based MMS message includes the following steps:
1. Create a text only region that is scrollable and has a width and height of 100%
2. Create an image region that has a width and height of 100%
3. Add media elements as follows:
   a. If the media element is an image, create a new slide and add the image to the slide. The image is formatted for the target device and centred on the screen. The image is shown for a default pre-set amount of time, for example, 6 seconds
   b. If the media element is audio, a new slide is added and the audio is added to the slide. The audio can be added as “background audio, in which case the slide duration is set to 1 second, otherwise the slide is shown for the length of the “formatted audio”. In this context, “formatted audio” means the audio has been converted to a format that can be played on the target device. The length and quality of audio are also determined automatically as follows:
      i. Using the maximum MMS message size based on the target device, gradually decrease the quality. If the size is still too great, reduce the length of the audio until the size will fit in the message.
   c. If the media element is video, a new slide is added and the video added to the slide. The duration of the slide is set to the length of the formatted video. The video is “formatted”, which means it has been converted to a format compatible with the target device. The length and quality of video are also determined automatically as follows:
      i. Using the maximum MMS message size based on the target device, gradually decrease the quality (frames per second, audio quality). If the size is still too great, reduce the length of the video until the size will fit in the message.
   d. If the media element is text, then a new slide is added and the text added to the slide. The duration of the slide is determined by counting the number of words in the text and dividing by 3.

As an alternative to creating an MMS message, the application server can create a Wireless Access Protocol/Wireless Markup Language (WML) message. The process of generating the WML from the data sent by the MME can be described as follows:
1. Image media elements are added as <IMG> tag to the WML
2. Text media elements are just added directly to the WML
3. Audio and Video media elements are added by adding a <A> tag to the WML with a HREF pointing to the converted (optimised) media.

In some embodiments, an element transferred to the mobile message editor comprises a URL pointing to Really Simple Syndication (RSS) data. In one of these embodiments, the application server downloads the RSS data. In another of these embodiments, the application server parses the RSS data. In still another of these embodiments, a description for an item in the RSS data is extracted and added to a mobile message. In some embodiments, an image associated with the item in the RSS data is added to a mobile message. In other embodiments, the parsing of the RSS data and the extraction of the items in the RSS data occurs prior to sending a mobile message.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

1-55. (canceled)

56: A method of enabling content for transmission in a mobile communication network, said method comprising the steps of:
(a) adapting a content resource for selection and transfer of at least one element in the content resource;
(b) transferring the element in the content resource to a mobile message editor; and
(c) composing a mobile message comprising the transferred element in the mobile message editor.

57: The method of claim 56, wherein step (a) further comprises generating an image of a display of said content resource for transfer to said mobile message editor.

58: The method of claim 56, wherein step (b) further comprises the steps of: (b-1) presenting, by said mobile message editor to a user of said content resource, an enumeration of a plurality of elements in said content resource; and (b-2) selecting, by the user, one or more elements from said enumeration for transfer to said mobile message editor.

59: The method of claim 56, wherein step (b) further comprises transferring, by a user of said content resource, said at least one element, and transferring a file from a file browser to said mobile message editor.

60: The method of claim 56, wherein step (b) further comprises selecting said element, dragging said element to said mobile message editor, and placing said element in said mobile message editor.

61: The method of claim 56, wherein step (b) further comprises copying said element from said content resource and pasting the copy of said element into said mobile message editor.

62: The method of claim 56, wherein step (b) further comprises transferring, by an automated structure of said content resource, said element of said content resource to said mobile message editor.

63: The method of claim 56, wherein step (b) further comprises transferring, by a script within said content resource, said element of said content resource to said mobile message editor.

64: The method of claim 56, wherein step (b) further comprises executing a script within said content resource to transfer said element of said content resource to said mobile message editor using an object model.

65: The method of claim 56, wherein step (c) further comprises storing a copy of a transferred element in said mobile message editor, and wherein said copy of said transferred element is stored in a form selected from the group consisting of a URL, a local file name and file contents, binary media data, text media data, Base64 encoded binary media data, media data, parsed HTML, and text.

66: The method of claim 56, wherein step (c) further comprises storing a reference to a transferred element in the mobile message editor, and further comprises the steps of (c-1) defining a plurality of attributes of said mobile message, and (c-2) editing one or more of said defined attributes.

67: The method of claim 56 further comprising the step of sending said composed message to at least one mobile device, (i) converting message data into a form suitable for transmitting to a separate component distinct from said mobile message editor, (ii) transmitting said converted message data to said separate component, (iii) processing by said separate component said message data, and (iv) sending said processed message data to said at least one mobile device, said mobile device able to retrieve said processed message data.

68: The method of claim 67, wherein step (iii) further comprises the steps of: storing on said separate component a copy of a transferred element for which message data was sent; and retrieving and storing, by said separate component, a copy of data identified by a URL associated with said transferred element.

69: The method of claim 68, wherein the data identified by said URL is RSS data, said separate component comprises an application server, and wherein step (iii) further comprises adding RSS data to a mobile message.

70: The method of claim 67, wherein step (iv) further comprises: sending a message type to said mobile device; identifying said mobile device; customizing, by said separate component, content of said message responsive to the identification of said mobile device; sending, by said separate component, said customized message to said mobile device; and receiving, by said mobile device, a communication having a format selected responsive to a message type, and wherein said message type requires the target device to contact an application server to retrieve said message content, the retrieval comprising the steps of: receiving a communication at a mobile device in accordance with said message type; receiving a communication at said application server from said mobile device comprising a request to download said message content to said mobile device; and customizing the content of the downloaded message in accordance with parameters of said mobile device.

71: The method of claim 67, wherein step (i) further comprises converting transferred elements into XML at said mobile message editor, step (ii) further comprises transmitting an element in said message to said separate component, and storing an element on said separate component for subsequent transmission to said at least one mobile device.

72: The method of claim 56, wherein step (c) further comprises altering data associated with said mobile message, editing a transferred elements, reducing a scale of an image size, converting said data from one media format to a second media format, identifying a portion of said data for transmission, and inserting additional content not originally specified by a sender of said message

73: The method of claim 72 further comprises the steps of: identifying information associated with said sender and inserting additional content responsive to the identification; identifying information associated with a recipient of said message and inserting additional content responsive to the identification; identifying information associated with a source of content inserted in said message and inserting additional content responsive to the identification; inserting additional content as an attachment to said message, said additional content being based on a system selected from the group consisting of a round-robin scheme, and a random selection of the content.

74: A system for enabling transmission of content in a mobile communication network comprising, said system comprising:
a content resource comprising at least one element;
an automated structure transmitting the at least one element; and
a mobile message editor receiving the at least one element and generating a mobile message for transmitting the at least one element.

75: The system of claim 74, wherein said content resource further comprises said automated structure, wherein said content resource further comprises an element, said element being selected from the group consisting of an image, a text, an audio, and a video, and wherein said automated structure further comprises an executable script and an executable script editor using an object model, and a code in a webpage, said code being selected from the group consisting of JavaScript, HTML text, and a supplemental markup code including a supplemental tag identifying an element and code associated with said element for transfer to said mobile message editor.
